(19) United States
(12) Patent Application Publication
(10) Pub. No.: US 2009/0234673 A1
(43) Pub. Date: Sep. 17, 2009

(54) METHOD AND SYSTEM FOR AUTOMATED MANAGEMENT OF TISSUE INFORMATION

(76) Inventors: Ming Li, San Diego, CA (US); Claudia Russell, San Diego, CA (US); Sam Eubanks, Leesburg, VA (US); Lee Smith, Spotsylvania, VA (US)

Correspondence Address: McDermott Will & Emery LLP, 11682 EL CAMINO REAL, SUITE 400, SAN DIEGO, CA, 92130-2047, US

(21) Appl. No.: 12/047,122

(22) Filed: Mar. 12, 2008

(51) Int. Cl. G06Q 50/00

(52) U.S. Cl. 705/3

(57) ABSTRACT

A method and system for automated management of tissue information, where the tissue information, which may include intake tissue information upon receiving a tissue, inventory information, preparation information, and usage information of the tissue is input to a database via a user terminal, where the user terminal prompts a user to input any required tissue information. A patient record, including the tissue information, may be created in the database. Post-operative patient reaction information may be added subsequently to the patient record. The tissue information and the patient record are searchable and updatable using one or more user terminals at various times.

### FIELD

The present disclosure relates generally to the automated management of tissue information, and more particularly, to a method and system for inputting to a database information relating to tracked movement of tissue through receiving, storage, issuance, implantation or transfer to post-operative activities.

### BACKGROUND

The Joint Commission on Accreditation of Healthcare Organizations (JCAHO) delineates multiple requirements regarding storage and maintenance of tissue and biologics. As a requirement for accreditation, records must be kept and updated at prescribed times to document the continuous monitoring of tissue.

The JCAHO requires a healthcare facility to implement standardized procedures to acquire, receive, store and issue tissues. For example, continuous temperature monitoring for refrigerators and freezers must be performed and documented. Records must be kept daily to show that a tissue was stored at the required temperature (e.g., 15°-30° C.). Further, all hospital records, including storage records of the tissue and all superseding procedures, are required to be kept for a minimum of 10 years.

Conventionally, doctors and healthcare facility staff manually record and update storage and maintenance information of tissue, using handwritten notes on a document affixed to a container holding the tissue. Merely recording such information on a single document may result in missing documentation required by the JCAHO due to unintentionally overlooking tissue information or forgetting to monitor storage conditions, as well as human error in the documentation. Missing and inaccurate records can result in product spoilage and/or endangering a patient by implanting contaminated tissue.

### SUMMARY

The presently disclosed embodiments are directed to solving one or more of the problems presented in the prior art, described above, as well as providing additional features that will become readily apparent by reference to the following detailed description when taken in conjunction with the accompanying drawings.

One or more aspects of the present disclosure are directed to a method for automated management of tissue information. The method comprises prompting a user to input tissue information at a user terminal; and inputting to a database the tissue information. According to certain aspects, a patient record is created in the database including the tissue information. The tissue information, according to certain embodiments, may include at least one of intake tissue information upon receiving a tissue, inventory information, preparation information, and usage information of the tissue.

One or more other aspects of the present disclosure are directed to a system for automated management of tissue information. The system comprises one or more user terminals configured to prompt a user to input to a database the tissue information; and a processing unit configured to create a record in the database including the tissue information. The tissue information, according to certain embodiments, may include at least one of intake tissue information upon receiving a tissue, inventory information, preparation information, and usage information of the tissue.

One or more aspects of the present disclosure are directed to a computer-readable medium storing instructions thereof for performing a method of automated management of tissue information. The method comprises prompting a user to input tissue information at a user terminal; and inputting to a database the tissue information. According to certain aspects, a patient record is created in the database including the tissue information. The tissue information, according to certain embodiments, may include at least one of intake tissue information upon receiving a tissue, inventory information, preparation information, and usage information of the tissue.

As will become evident by the following Description and Drawings, automated management of tissue information ensures data integrity, thereby reducing tissue spoilage and providing improved patient safety with better clinical outcomes. The prompting of a user to input tissue data better ensures that the data will be entered and the records will have the required integrity.

Of course, the present invention is not limited to the aforementioned embodiments, and other features of the embodiments will become apparent after review of the hereinafter set forth Brief Description of the Drawings, Detailed Description, and the Claims, or may be learned by practice of the invention.

### BRIEF DESCRIPTION OF THE DRAWINGS

The foregoing aspects of the embodiments described herein will become more readily apparent by reference to the following detailed description when taken in conjunction with the accompanying drawings wherein:

FIG. 1 is a graphical illustration of a system for automated management of tissue information, according to one or more disclosed embodiments.

FIG. 2 is a flow diagram showing a method for automated management of tissue information, according to one or more disclosed embodiments.

FIG. 3 is a flow diagram showing a method for updating tissue information, according to one or more disclosed embodiments.

FIGS. 4(a) and 4(b) are screenshots of intake information of a tissue entered by a user, according to one or more disclosed embodiments.

FIG. 5 is a screenshot showing prompted storage information, according to one or more disclosed embodiments.

FIG. 6 is a screenshot showing prompted patient information, according to one or more disclosed embodiments.

FIG. 7 is a screenshot showing preparation information provided to a user at a user terminal, according to one or more disclosed embodiments.

FIG. 8 is a screenshot showing prompted preparation information, according to one or more disclosed embodiments.

FIG. 9 is a screenshot showing post-operative information, according to one or more disclosed embodiments.

FIG. 10 is a screenshot showing prompted post-operative information, according to one or more disclosed embodiments.

### DETAILED DESCRIPTION

Reference will now be made in detail to the presently disclosed embodiments, examples of which are illustrated in the accompanying drawings, wherein like reference numerals refer to like elements throughout.

In the following detailed description, numerous specific details are set forth to provide a full understanding of the subject technology. It will be obvious, however, to one ordinarily skilled in the art that the subject technology may be practiced without some of these specific details. In other instances, well-known structures and techniques have not been shown in detail so as not to obscure the subject technology.

Embodiments of the present disclosure address and solve problems related to tissue management, including that of maintaining the integrity of data records related to the tissue, which can be caused, for example, by failure to record, or attempting to maintain and secure manual documentation. These and other concerns are solved, at least in part, by embodiments of the present invention that provided, for example, a method for automated management of tissue information. The method comprises prompting a user to input tissue information at a user terminal; and inputting to a database the tissue information. According to certain embodiments, a patient record is created in the database including the tissue information.

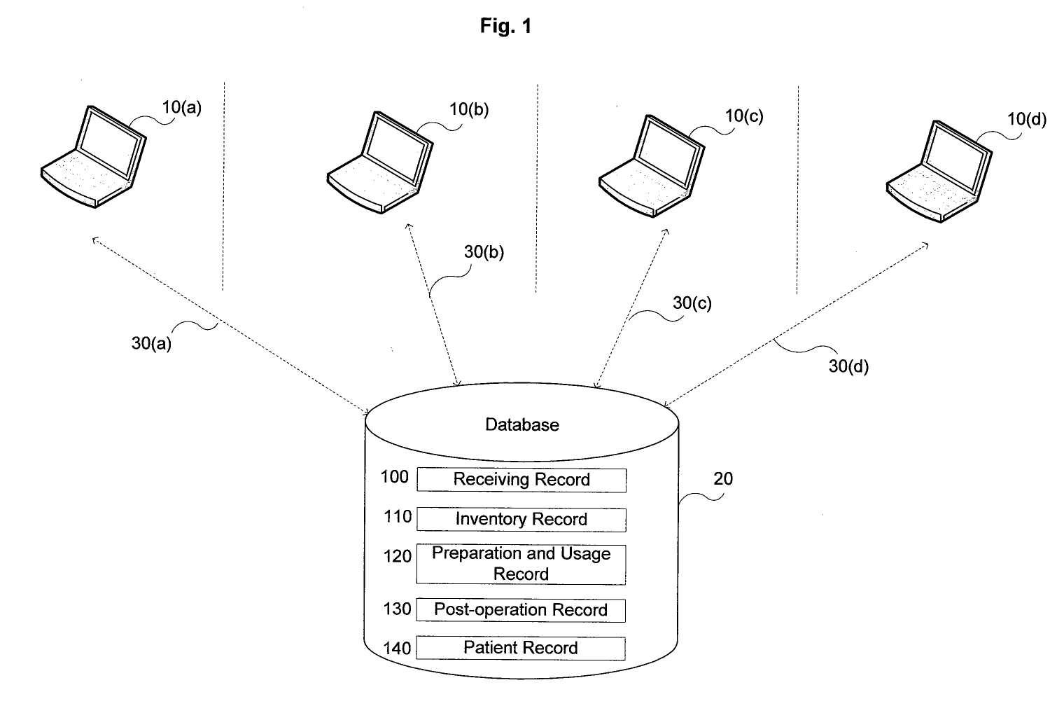

FIG. 1 is a graphical illustration of a system for automated management of tissue information, according to one or more disclosed embodiments. Upon receipt of tissue at an unloading dock or a tissue bank, an electronic reception record 100 is established in database 20 for the tissue via user terminal 10(a). A user (not shown) may be prompted at terminal 10(a), for example, to enter a tissue ID and type. It is noted that generation of the tissue ID may be performed as described in application Ser. No. ______, entitled “METHOD AND SYSTEM FOR IMPLANT RECORD INTAKE USING A UNIQUE IMPLANT ID”, with the same inventors as the present application and filed concurrently herewith, and which is expressly incorporated herein by reference.

In addition, the user may be prompted to enter intake tissue information including a tissue lot number, an expiration date, a supplier name, necessary storage temperature, the date and time at which the tissue is received, the person receiving and/or inspecting the tissue, receipt of tissue testing results and/or the condition of the tissue upon arrival. Of course, the foregoing information entered into database 20 via user terminal 10(a) is merely exemplary and other information, as well as various combinations of the foregoing information, may be entered.

According to certain embodiments, one or a plurality of user terminals 10(a) may be used to enter the intake tissue information. Each user terminal 10(a) may prompt a user to enter required intake tissue information and communicates the intake tissue information to database 20 via a connection 30(a), which may be a wireless connection (e.g., WiFi) or a hard-wired connection (e.g., a local area network). According to certain embodiments, the user terminal 10(a) is a device previously incorporated into a local area network and/or wireless local area network, complying with IEEE 802.11 standards. According to other embodiments, user terminal 10(a) may communicate with database 20 via the internet. Any conventional means of communication, however, may be employed between the user terminal 10(a) and database 20.

After receipt of the tissue, according to certain embodiments an inventory record 110 including inventory information may be established in database 20, which may include movement and acceptance information at various locations, dispensing information and storage conditions of the tissue. The storage temperature of the tissue may be obtained every 15 minutes using, for example, an automated supply dispensing system; however, any conventional temperature monitoring device may be employed. Inventory information may be input to the database 20 using one or a plurality of user terminals 10(b), which may be an automated supply dispensing system that stores and monitors the storage temperature of the tissue automatically every 15 minutes, for example, and transmits the storage temperature to database 20.

Each user terminal 10(b) may prompt a user to input required inventory information, and communicates the inventory information to database 20 via a connection 30(b). According to certain embodiments, the user may periodically update the inventory record 110 at predetermined time intervals using one or more user terminals 10(b). In addition, the user may search for the inventory record 110 in the database 20 using the tissue ID or any other category of inventory information in order to check the status of the tissue.

Connection 30(b) may be a wireless connection (e.g., WiFi) or a hard-wired connection (e.g., a local area network). According to certain embodiments, the user terminal 10(b) is a device previously incorporated into a local area network and/or wireless local area network, complying with IEEE 802.11 standards. According to other embodiments, user terminal 10(b) may communicate with database 20 via the internet. Any conventional means of communication, however, may be employed between the user terminal 10(b) and database 20.

According to certain embodiments, a preparation and usage record 120 including preparation and usage information may be established before the tissue is implanted. The preparation information may include the date, the user, the preparation methodology including a reconstituting agent, ancillary materials and the condition of the tissue before implantation. The usage information may include the date, the patient the clinicians involved with implantation, procedure steps for the implantation and the condition of the tissue during implantation. Of course, these specific items of preparation and usage information are merely exemplary, and other information may be included.

Preparation and usage information may be entered at one or a plurality of user terminals 10(c), possibly located within an operating room. Each user terminal 10(c) may prompt a user to input required preparation and usage information and communicates the inventory information to database 20 via a connection 30(c), which may be a wireless connection (e.g., WiFi) or a hard-wired connection (e.g., a local area network). According to certain embodiments, the user terminal 10(c) is a device previously incorporated into a local area network and/or wireless local area network, complying with IEEE 802.11 standards. According to other embodiments, user terminal 10(c) may communicate with database 20 via the internet. Any conventional means of communication, however, may be employed between the user terminal 10(c) and database 20.

According to certain embodiments, a post-operation record 130 may be established following tissue implantation. The post-operation record 130 may include post-operative patient reaction information such as the patient name, medical record number, implanting physician, type of tissue implanted, date of implant, date of any adverse outcome, patient symptoms, name of person reporting adverse reaction, name of person obtaining the post-operative patient reaction information and the date the post-operative patient reaction information was obtained. The functionality of the implant should be tested to determined if an explant is necessary. Results of such tests also must be included in the post-operative patient reaction information. Of course, these items of information are merely exemplary, and additional information may be included without departing from the scope of the present disclosure.

Post-operative patient reaction information may be entered at one or a plurality of user terminals 10(d). Each user terminal 10(d) may prompt a user to input required post-operative patient reaction information and communicates the inventory information to database 20 via a connection 30(d), which may be a wireless connection (e.g., WiFi) or a hard-wired connection (e.g., a local area network). According to certain embodiments, the user terminal 10(d) is a device previously incorporated into a local area network and/or wireless local area network, complying with IEEE 802.11 standards. According to other embodiments, user terminal 10(d) may communicate with database 20 via the internet. Any conventional means of communication, however, may be employed between the user terminal 10(d) and database 20.

According to certain embodiments, a patient record 140 is created in database 20 which may include the tissue ID along with the corresponding intake tissue information, inventory information, preparation information, and usage information of the tissue that is associated with a patient. Subsequently, the post-operative patient reaction information may be added to the patient record.

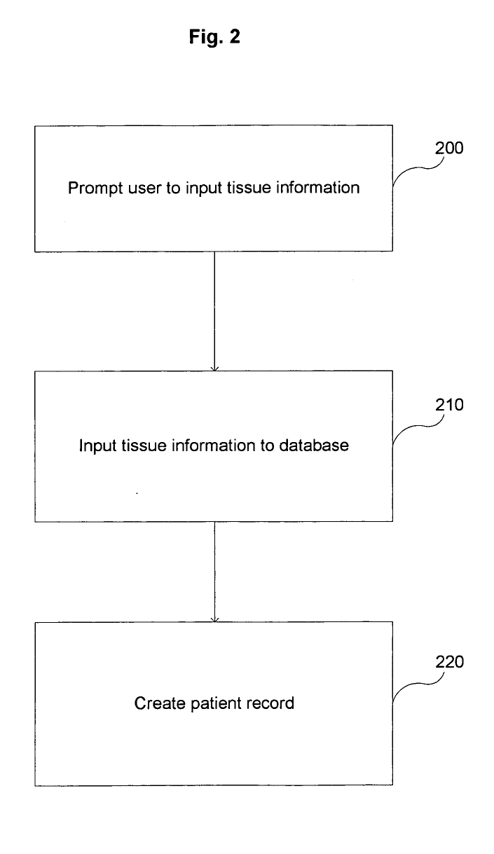

FIG. 2 is a flow diagram showing a method for automated management of tissue information, according to one or more disclosed embodiments. At operation 200, a user is prompted to input tissue information into a user terminal 10(a)-10(d). From operation 200, the process proceeds to operation 210, where the user inputs at the user terminal any required tissue information. The tissue information may include intake tissue information upon receiving a tissue, inventory information, preparation information, and usage information of the tissue. The tissue information may be input at various user terminals 10(a)-10(d) at various times, and is stored in database 20 communicatively coupled to the user terminal(s) 10(a)-10(d).

According to certain embodiments, from operation 210, the process may proceeds to operation 220, where a patient record is created in database 20, which includes the tissue information associated with a particular patient. A tissue ID unique to the tissue to be implanted may be appended to the patient record.

The tissue information may be updated manually or automatically at various times and at various user terminals 10(a)-10(d) to document changing conditions or locations of the tissue, and/or to document the continuous monitoring of storage conditions, as required by the JCAHO. For example, the tissue may be moved to a different storage area or held under different storage conditions, and the storage temperature of the tissue must be monitored every 15 minutes. In this case, the inventory record 110, for example, must be updated in database 20 accordingly to reflect the new location and/or storage condition, as well as the newly monitored storage temperature. Automated inventory methods may be employed to reflect the new storage location of the tissue.

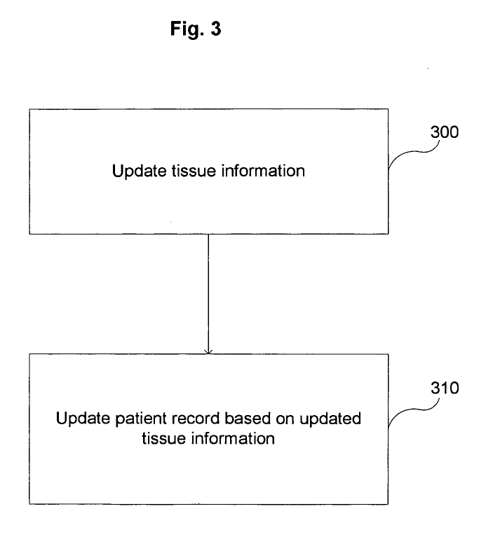

FIG. 3 is a flow diagram showing a method for updating tissue information, according to one or more disclosed embodiments. At operation 300, a user at a user terminal 10(a)-10(d) updates tissue information by inputting new and/or different information regarding a particular tissue. Also, the tissue information can be updated automatically, such as providing temperature readings every 15 minutes, for example. The terminal 10(a)-10(d) communicates the information to database 20 via communication line 30(a)-30(d), respectively, where the updated tissue information is stored.

From operation 300, the process continues to operation 310 where a processor (not shown) communicatively coupled to database 20 updates the patient record associated with the tissue with the new and/or different information.

The patient record 140, as well as any tissue information relating to the tissue, may be searchable in the database 20 based on, for example, the tissue ID, using one of the user terminal(s) 10(a)-10(d). In this manner, a user is able to determine past and current conditions and exact location of a tissue at any time and from various locations.

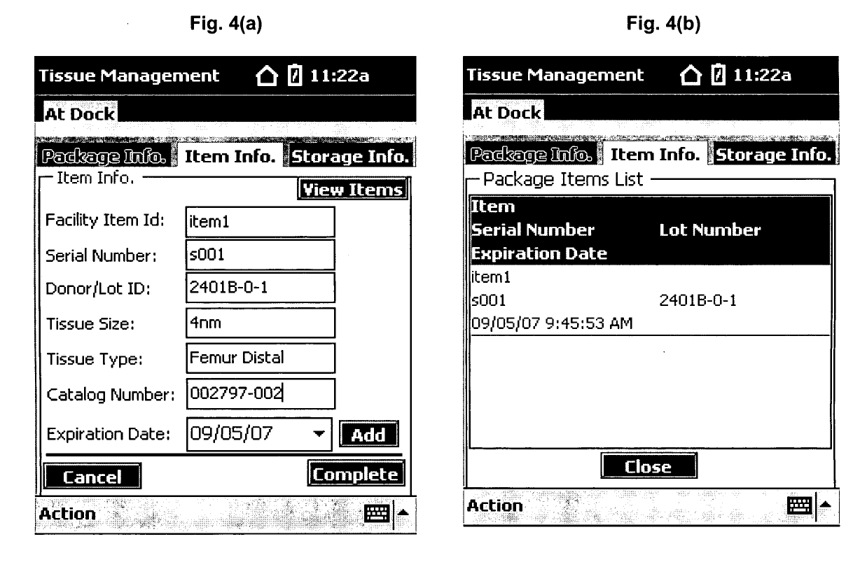

FIGS. 4(a) and 4(b) are screenshots of intake information of a tissue entered by a user, according to one or more disclosed embodiments. As shown in FIG. 4(a), a user terminal 10(a) at the loading dock, for example, prompts a user to enter a Facility Item ID, a Serial Number, a Donor/Lot ID, a Tissue Size, a Tissue Type, a Catalog Number and an Expiration Date. Of course, these items are merely exemplary, and the user terminal 10(a) may prompt the user to enter other information or various combinations of this exemplary information. Further, various user terminals 10(a)-10(d) may be used to input the intake information. After inputting the prompted information, FIG. 4(b) shows the tissue information, as it is stored in database 20.

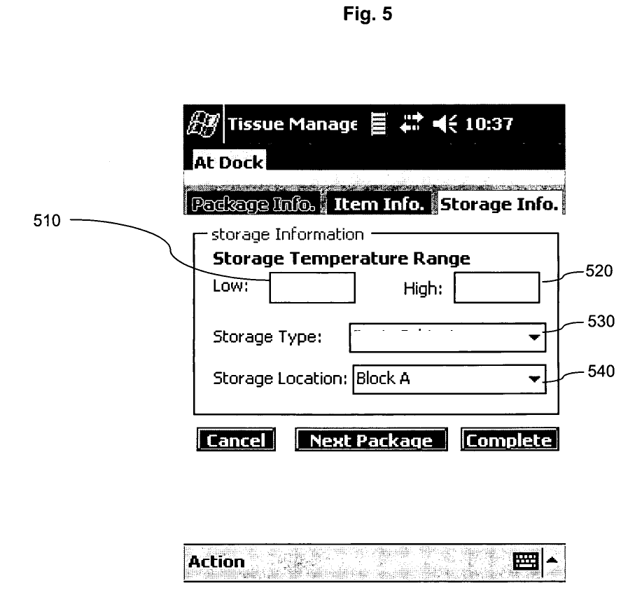

FIG. 5 is a screenshot showing prompted storage information, according to one or more disclosed embodiments. For example, the user may be prompted at user terminal 10(b), for example, to enter a temperature range including a low storage temperature 510 and a high storage temperature 520. The user may also be prompted to enter a storage type 530 (e.g., a type of cabinet in which tissue is stored), and a storage location 540 within a healthcare facility. Of course, these items are merely exemplary, and the user terminal 10(b) may prompt the user to enter other information or various combinations of this exemplary information. Further, various user terminals 10(a)-10(d) may be used to input the storage information. The storage information is stored in database 20 and associated with previously input tissue information.

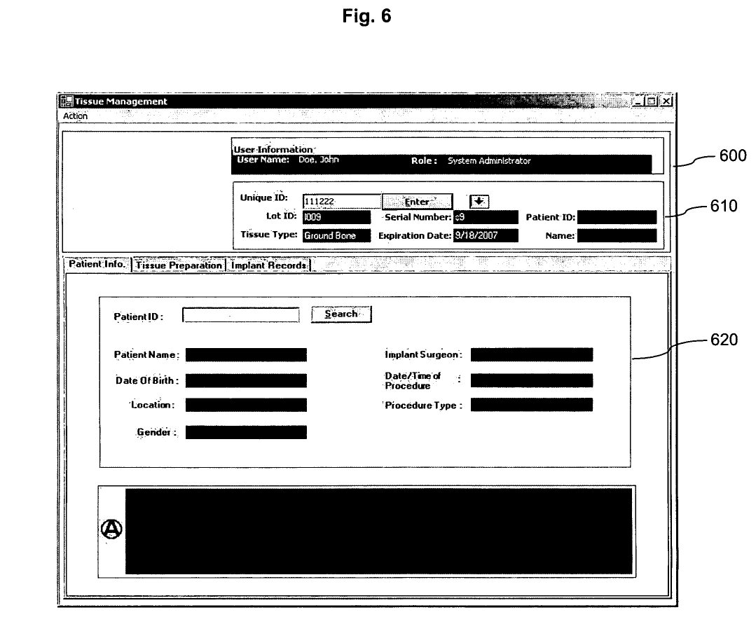

FIG. 6 is a screenshot 600 showing prompted patient information, according to one or more disclosed embodiments. As shown in FIG. 6, a user may search for a particular tissue using a unique tissue ID at box 610. Of course, one skilled in the art would understand that various information items may be used to search for the particular tissue (e.g., a lot number or serial number). Once a patient is scheduled to be implanted with a particular tissue, patient information 620 may be input at a user terminal 10(a)-10(d). The patient information 620 may include a patient ID, patient name, date of birth, location and gender. The patient information 620 may further include the surgeon performing the implantation, the date/time of the implantation, and the procedure type. Of course, these items are merely exemplary, and the user terminal 10(a)-10(d) may prompt the user to enter other information or various combinations of this exemplary information. Thereafter, patient information 620 will be stored in the patient record 140 within database 20, and associated with the corresponding tissue information.

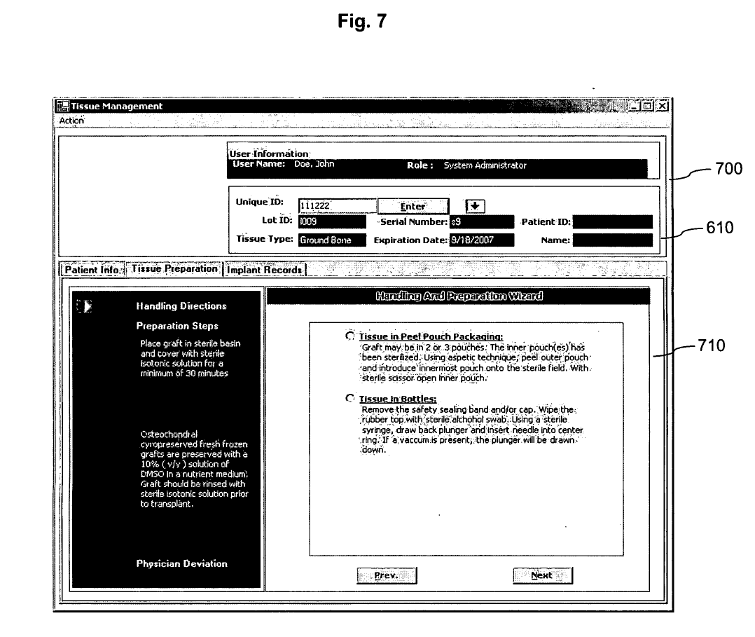

FIG. 7 is a screenshot 700 showing preparation information provided to a user at a user terminal, according to one or more disclosed embodiments. As shown in FIG. 7, a user may search for a particular tissue using a unique tissue ID at box 610. Of course, one skilled in the art would understand that various information items may be used to search for the particular tissue (e.g., a lot number or serial number). Using a user terminal 10(c) (e.g., in an operating room), a user (e.g., a physician or medical staff member) may be prompted by a handling and preparation wizard 710 providing handling and preparation directions for implanting a particular tissue identified at box 610. This automated handling and preparation information assures that the user does not overlook a preparation step in preparing the tissue for implantation.

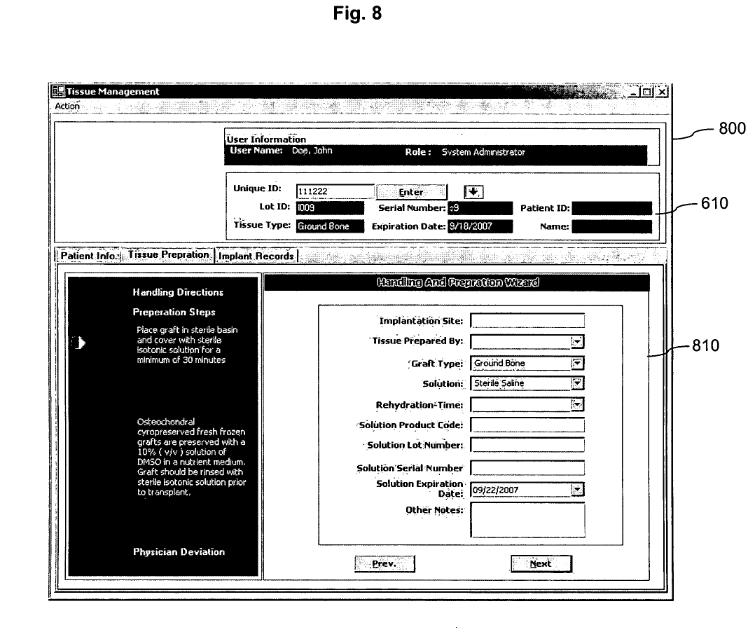

FIG. 8 is a screenshot 800 showing prompted preparation information, according to one or more disclosed embodiments. As shown in FIG. 8, a user may search for a particular tissue using a unique tissue ID at box 610. Of course, one skilled in the art would understand that various information items may be used to search for the particular tissue (e.g., a lot number or serial number). Using a user terminal 10(c) (e.g., in an operating room), a user (e.g., a physician or medical staff member) may be prompted by a handling and preparation wizard 810 to enter particular preparation information for a particular tissue identified at box 610. The preparation information may include, for example, the implantation site, who is preparing the tissue, graft type, a solution used, re-hydration time, a solution product code, a solution lot number, a solution serial number, a solution expiration date, and any other notes. Automated handling and preparation information assures that the user does not overlook a preparation step in preparing the tissue for implantation. Of course, these items are merely exemplary, and the user terminal 10(c) may prompt the user to enter other information or various combinations of this exemplary information.

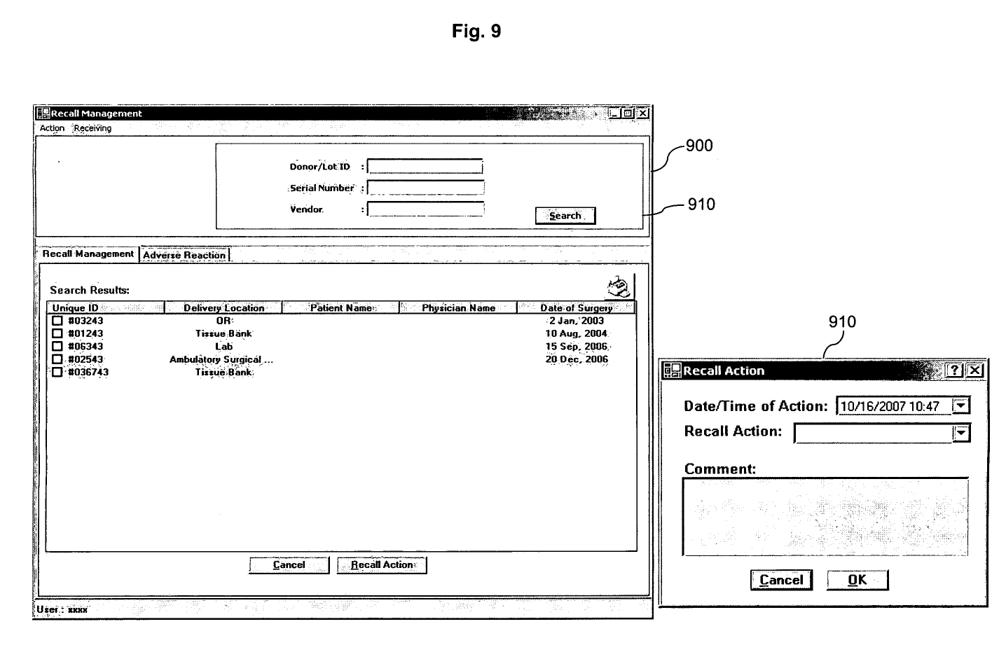

FIG. 9 is a screenshot 900 showing recall management, according to one or more disclosed embodiments. At box 910, a user may search for a particular tissue by donor/lot ID, serial number or vendor. Of course, one skilled in the art would understand that various information items may be used to search for the particular tissue. A user may choose a particular tissue from the search results, which provide unique tissue IDs, delivery locations, patient names, physician names and date of surgeries. By choosing a particular tissue, any recall action 910 will appear, which may include the date and time of the recall action 910 and the type of recall action 910. The user may add additional comments to be recorded in database 20 and associated with the particular tissue and the corresponding patient record 140. For example, the user may enter any steps performed to notify the patient receiving the tissue or the surgeon performing the implant of a recall action. The user may also enter any notification procedures taken in order to notify the vendor of the tissue subject to the recall action.

In the case of a recall action, the recall management system shown in FIG. 9 allows a user to easily search for information relating to a particular tissue, donor or vendor. By a search using the donor/lot ID, the serial number or the vendor, a user may determine the patient receiving the recalled tissue and the surgeon performing the implant. Thus, all tissue information of the recalled tissue may be easily obtained and steps may be taken to notify the patient, surgeon and vendor of the recall action.

Further, the recall management system shown in FIG. 9 provides an automated mechanism by which a user may produce documentation required during a JCAHO audit, for example. In the case that a healthcare facility receives a recall notice, the JCAHO may request documentation regarding what tissue of a specified lot number has been implanted and to whom. Documentation may also be requested to show what steps have been taken to notify the patient receiving the tissue and the surgeon performing the implant. Notification information as to whether the vendor of the tissue has been notified may also be requested. Thus, as all of the tissue information is previously entered and centrally stored in database 20 a user may easily produce an audit trail associated with each tissue.

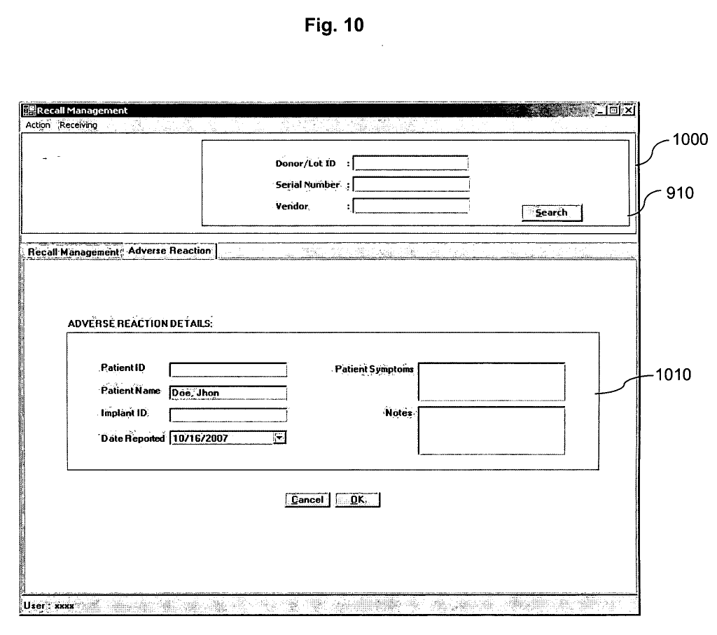

FIG. 10 is a screenshot 1000 showing prompted post-operative information, including adverse reactions, according to one or more disclosed embodiments. At box 910, a user may search for a particular tissue by donor/lot ID, serial number or vendor, using a user terminal 10(a)-10(d). Of course, one skilled in the art would understand that various information items may be used to search for the particular tissue. At box 1010, the user may record adverse reaction details associate with the particular tissue, such as a patient ID, a patient name, an implant ID, the date any adverse reactions were reported, the patient symptoms, any additional notes and the like. The adverse reaction details 1010 will be stored in database 20 and associated with the corresponding tissue information and patient record 140.

The methods and systems described herein solve the challenges that acute care hospitals face in managing tissue and biologics from the point of intake through storage, implantation, records archival and recall management. The foregoing aspects provide the opportunity to generate an automated process that will help hospitals fully comply with the JCAHO regulations and contribute to improved patient outcomes. Specifically, automated management of tissue information ensures data integrity, thereby reducing tissue spoilage and providing improved patient safety with better clinical results.

Moreover, by prompting a user to input certain required information, a hospital or healthcare facility can avoid having missing documentation required by the JCAHO due to unintentionally overlooking tissue information or forgetting to monitor storage conditions. Since the tissue information, and the associated patient record, is stored on a centralized database 20, all tissue information is easily searchable and updatable.

In addition, storing all tissue information on a centralized database 20, allows easy recall management. Patients, surgeons and vendors may be quickly and efficiently determined and notified of a recall action, and all tissue information relating to a recalled tissue may be easily produced. Also, audit trail production is simplified since all information regarding the recall action and notification procedures for the patient, surgeon and/or vendor are easily searchable, as all tissue information is associated with the Donor/Lot ID and the serial number of the tissue in the database 20.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

It is understood that the specific order or hierarchy of steps or operations in the processes disclosed is an illustration of exemplary approaches. Based upon design preferences, it is understood that the specific order or hierarchy of steps or operations in the processes may be rearranged. Some of the steps may be performed simultaneously. The accompanying method claims present elements of the various steps or operations in a sample order, and are not meant to be limited to the specific order or hierarchy presented.

What is claimed is:

1. A method for automated management of tissue information, comprising:
prompting a user to input tissue information at a user terminal; and
inputting to a database the input tissue information.

2. The method of claim 1, further comprising creating a patient record in the database including the input tissue information.

3. The method of claim 1, wherein the tissue information includes at least one of intake tissue information upon receiving a tissue, inventory information, tissue preparation information, and usage information of the tissue.

4. The method of claim 1, wherein the patient record further includes post-operative patient reaction information.

5. The method of claim 1, wherein the database is centralized.

6. The method of claim 1, further comprising updating the tissue information in the database via the user terminal.

7. The method of claim 6, further comprising updating the patient record based on the updated tissue information.

8. The method of claim 6, wherein the updating is capable of being performed at one or a plurality of user terminals.

9. The method of claim 1, wherein the database is accessible via one or a plurality of user terminals.

10. The method of claim 1, wherein the tissue information in the database is searchable using one or more user terminals.

11. The method of claim 3, wherein the intake tissue information includes at least one of a tissue ID and type, a tissue lot number, an expiration date, a supplier name, a storage temperature, a date and a time the tissue is received, an ID of a person receiving and inspecting the tissue, a receipt of tissue testing results and a condition of the tissue.

12. The method of claim 3, wherein the inventory information includes at least one of location information of the tissue and storage conditions.

13. The method of claim 3, wherein the preparation information includes at least one of user preparation methodology, a reconstituting agent, ancillary materials and condition of the tissue.

14. The method of claim 3, wherein the usage information includes at least one of an ID of a patient, a date of use, a procedure using the tissue and a condition of the tissue.

15. The method of claim 4, wherein the post-operative patient reaction information includes at least one of a patient ID, a medical record number, an implanting physician, a type of tissue implanted, a date of implant, a date of adverse outcome, patient symptoms, name of a person reporting an adverse reaction and a date of any information obtained.

16. A system for automated management of tissue information, comprising:
one or more user terminals configured to prompt a user to input to a database the tissue information; and
a processing unit configured to create a record in the database including the input tissue information.

17. The system of claim 16, wherein the record includes patient information associated with the tissue information.

18. The system of claim 16, wherein the tissue information includes at least one of intake tissue information upon receiving a tissue, inventory information, preparation information, and usage information of the tissue.

19. The system of claim 16, wherein the patient record further includes post-operative patient reaction information.

20. The system of claim 16, wherein the database is centralized.

21. The system of claim 16, wherein the user updates the tissue information at the one or more terminals.

22. The system of claim 21, wherein the processing unit updates the patient record based on the updated tissue information.

23. The system of claim 16, wherein the database is accessible via the one or more user terminals.

24. The system of claim 16, wherein the tissue information is searchable using the one or more user terminals.

25. The system of claim 18, wherein the intake tissue information includes at least one of a tissue ID and type, a tissue lot number, an expiration date, a supplier name, a storage temperature, a date and a time the tissue is received, an ID of a person receiving and inspecting the tissue, a receipt of tissue testing results and a condition of the tissue.

26. The system of claim 18, wherein the inventory information includes at least one of location information of the tissue and storage conditions.

27. The system of claim 18, wherein the preparation information includes at least one of user preparation methodology, a reconstituting agent, ancillary materials and condition of the tissue.

28. The system of claim 18, wherein the usage information includes at least one of an ID of a patient, a date of use, a procedure using the tissue and a condition of the tissue.

29. The system of claim 18, wherein the post-operative patient reaction information includes at least one of a patient ID, a medical record number, an implanting physician, a type of tissue implanted, a date of implant, a date of adverse outcome, patient symptoms, name of a person reporting an adverse reaction and a date of any information obtained.

30. A computer-readable medium storing instructions thereon for performing a method for automated management of tissue information, comprising:
prompting a user to input tissue information at a user terminal; and
inputting to a database the tissue information.
